(19) United States
(12) Patent Application Publication
(10) Pub. No.: US 2010/0170584 A1
(43) Pub. Date: Jul. 8, 2010

(54) METHOD OF MANUFACTURING Y-SHAPE REFRIGERANT DISTRIBUTOR FOR AIR CONDITIONING AND Y-SHAPE REFRIGERANT DISTRIBUTOR MANUFACTURED THEREBY

(75) Inventors: Seong Taek Chung, Jinju (KR); Young Sam Kwon, Seoul (KR)

Correspondence Address: LRK Patent Law Firm, 1952 Gallows Rd, Suite 200, Vienna, VA, 22182, US

(73) Assignee: CETATECH, INC., Sacheon (KR)

(21) Appl. No.: 12/663,942

(22) PCT Filed: Jun. 13, 2008
(86) PCT No.: PCT/KR2008/003327

§ 371 Date: Dec. 10, 2009

(30) Foreign Application Priority Data
Jun. 15, 2007 (KR) 10-2007-0058670

(51) Int. Cl. F16L 41/00; B22F 3/12

(52) U.S. Cl. 137/561 A; 419/38

(57) ABSTRACT

Disclosed is a method of manufacturing a refrigerant distributor for air conditioning and a refrigerant distributor manufactured thereby. The manufacturing method includes mixing copper powder with 30-60 vol % of a binder based on the volume of the copper powder, thus preparing a mixture for injection molding, subjecting the mixture to injection molding using a mold, thus producing an injection molded body having the shape of a distributor, removing the binder from the injection molded body, and sintering the binder-free molded body in a sintering furnace at 800-1150° C. in a reducible or inert atmosphere, the method being thereby favorable for mass production owing to omission of additional mechanical processing and enabling the manufacture of a distributor having a smaller size, as for adaptation for the miniaturization of an apparatus, reducing loss of material, and leading to low manufacturing costs.

### TECHNICAL FIELD

The present invention relates to a method of manufacturing a refrigerant distributor and a refrigerant distributor manufactured by the method, and more particularly, to a method of manufacturing a refrigerant distributor for air conditioning, which is provided in a pipeline for circulating a refrigerant and in a heat exchanger such as an indoor unit and an outdoor unit, in order to improve the evaporation of the refrigerant, and to a refrigerant distributor manufactured thereby.

### BACKGROUND ART

An air conditioning system, for example, a refrigerator or an air conditioner, is responsible for circulating a refrigerant through a series of cooling cycles, each cooling cycle consisting of compression, condensation, expansion and evaporation stages so that the refrigerant is evaporated in a corresponding heat exchanger (outdoor unit or indoor unit) to thus absorb peripheral heat, thereby realizing air conditioning or cooling functions.

Specifically, in a typical cooling cycle, a refrigerant is compressed to high-temperature and high-pressure by a compressor, and is then converted into a liquid refrigerant in a high-temperature and high-pressure state through heat emission by means of a condenser. Further, the liquid refrigerant is converted into a low-temperature and low-pressure state through pressure drop using an expander such as a capillary tube or an expansion valve. The refrigerant in a low-temperature and low-pressure state absorbs peripheral heat and evaporates via an evaporator, so that the surrounding is maintained to a low temperature. After the completion of the evaporation, the gaseous refrigerant is returned to the compressor, and the above cycle is repeated.

In order to increase the heat exchanging capability of the refrigerant which is supplied into the evaporator following the expander in the cooling cycle, pressure drop should be reduced along the length of the evaporator. To this end, the refrigerant is supplied into the evaporator in a manner such that it is distributed into a plurality of flow paths, thus controlling the amount of the refrigerant, thereby increasing the evaporating capability. As such, for the distribution of the refrigerant into the plurality of flow paths, a distributor is typically installed.

FIG. 1 is a perspective view showing a conventional distributor for air conditioning.

With reference to FIG. 1, a conventional distributor is formed in such a manner that a single inlet portion 20 having one inlet port mutually communicates with a plurality of outlet portions 30 having a plurality of outlet ports (a distributor having two outlet ports is illustrated in the drawing) through an expansion tube type body 10 which constitutes the center of the distributor, and thereby the refrigerant supplied into the distributor via the single inlet portion 20 is uniformly distributed and discharged to the outside through the outlet portions 30 having the plurality of outlet ports.

The conventional distributor is manufactured through a series of mechanical procedures shown in FIG. 2.

Specifically, a copper pipe formed of copper is cut into a predetermined size (FIG. 2(a)), after which one side of the cut pipe is subjected to swaging, thus reducing the cross-section thereof, thereby forming the inlet portion (FIG. 2(b)). Thereafter, the halfway portions of the outer surface of the other side of the pipe are pressed, thereby forming the plurality of outlet portions on the basis of the pressed halfway portions (FIG. 2(c)). Finally, the pressed portions are brazed, thereby completing the distributor.

For convenience of assembly with connection pipes which are to be connected to the distributor, as shown in FIG. 1, predetermined positions of the outer surfaces of the inlet portion and the outlet portions of the distributor are punched, thus forming protrusions 40 on the inner surfaces of the inlet portion and the outlet portions. Thereby, the insertion depth of the connection pipe is limited.

However, the method of manufacturing the distributor presented above is disadvantageous because a plurality of mechanical process steps requiring high precision need be conducted, undesirably decreasing mass productivity of products, and rendering the above manufacturing method unsuitable for mass production. Further, the distributor manufactured through the above method is problematic in that the brazed portions become detached and separated, resulting from the difference in temperature between the refrigerant and the outside caused during the use of the distributor, and heat transfer in the course of connecting another pipe to the distributor through welding, thereby undesirably unbalancing the flow of the refrigerant and leaking the refrigerant.

Moreover, because the two outlet portions are formed through pressing, an excessively long material is required to ensure the area which is pressed, and further, the space in the product required for pressing and brazing is wide, resulting in a large distributor.

### DISCLOSURE OF INVENTION

### Technical Problem

Accordingly, the present invention has been made keeping in mind the above problems occurring in the related art, and the present invention provides a method of manufacturing a refrigerant distributor for air conditioning, which is suitable for mass production without the need for a plurality of mechanical process steps requiring high precision, obviates a brazing process in the manufacture of the distributor, and enables the manufacture of a compact distributor adapted for miniaturization of an apparatus.

In addition, the present invention provides a refrigerant distributor for air conditioning, which prevents unbalanced flow of a refrigerant and leakage of the refrigerant, because of the elimination of the need for a brazing process.

### Technical Solution

According to an aspect of the present invention, a method of manufacturing a refrigerant distributor for air conditioning may comprise mixing copper powder, which is a base material, with 30˜60 vol % of a binder based on the volume of the copper powder, thus preparing a mixture for injection molding, subjecting the mixture thus prepared to injection molding using a mold, thus producing an injection molded body having the shape of a distributor, removing the binder from the injection molded body having said shape, and sintering the binder-free molded body in a sintering furnace at 800˜1150° C. in a reducible or inert atmosphere.

As such, the binder may be removed through solvent debinding, by which the binder contained in the molded body is dissolved using a solvent, and through thermal debinding, by which the molded body is heated to burn and remove the binder dissolved through solvent debinding.

In the solvent debinding process, the solvent may include n-hexane, heptane or alcohol.

According to another aspect of the present invention, a refrigerant distributor for air conditioning may be manufactured through the above method and may comprise a single inlet portion and two outlet portions which communicate with each other to provide an integrated form, in which the two outlet portions have a central partition disposed therebetween, and the inlet portion and the outlet portions have protrusions which are integrally formed on the inner surfaces thereof to guide and limit the insertion depth of a connection pipe which is connected to the distributor.

### Advantageous Effects

According to the present invention, a final distributor is manufactured in an integrated form through injection and sintering. Thus, additional mechanical processing, for example, pressing and brazing, are not required to form a plurality of outlet portions. Consequently, the manufacturing process is simplified, thus increasing mass productivity of products and rendering the process favorable for mass production. The distributor can be manufactured to have a smaller size than conventional distributors, advantageously reducing the loss of the material, thereby decreasing manufacturing cost. As well, it is possible to manufacture a distributor adapted for miniaturization of an apparatus.

Further, because the distributor obtained through the method of the present invention is in an integrated form without any brazed portions, there is no concern about unbalanced flow of the refrigerant and leakage thereof resulting from the melting of the brazed portions.

### BRIEF DESCRIPTION OF THE DRAWINGS

FIG. 1 is a perspective view showing a conventional distributor for air conditioning;

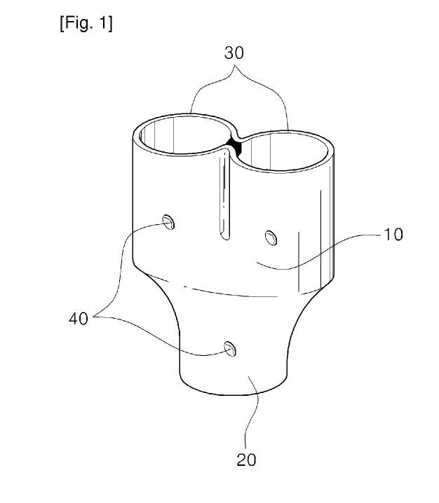

FIG. 2 is a view schematically showing a process of manufacturing the conventional distributor;

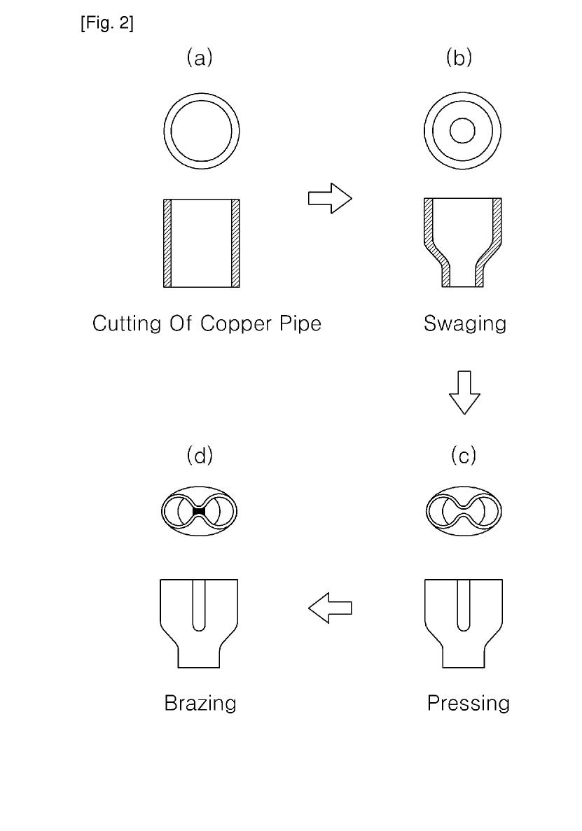

FIG. 3 is a view schematically showing a process of manufacturing a refrigerant distributor according to an embodiment of the present invention;

FIG. 4 is a perspective view showing the refrigerant distributor which is manufactured through the process of the present invention; and

FIGS. 5 and 6 are cross-sectional views showing the refrigerant distributor taken along the lines A-A and B-B of FIG. 4, respectively.

### DESCRIPTION OF THE REFERENCE NUMERALS IN THE DRAWINGS

2: inlet portion

3: outlet portion

300: central partition

4: protrusion

### MODE FOR THE INVENTION

Hereinafter, a detailed description will be given of a method of manufacturing a refrigerant distributor according to a preferred embodiment of the present invention in conjunction with the drawings.

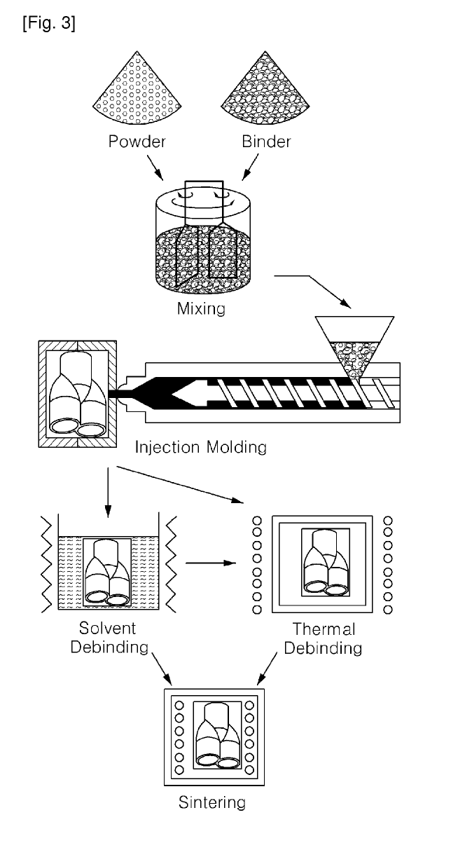

FIG. 3 schematically shows the process of manufacturing the refrigerant distributor according to the present invention. The refrigerant distributor of the present invention may be manufactured through a series of manufacturing procedures as described below.

Specifically, as shown in FIG. 3, the refrigerant distributor for air conditioning according to the present invention is manufactured by mixing copper powder, which is the base material, with a binder, thus preparing a mixture for injection molding, subjecting the mixture thus prepared to injection molding using a mold, thereby producing an injection molded body having the shape of a distributor, removing the binder from the injection molded body having said shape, and sintering the binder-free molded body in a sintering furnace under predetermined temperature conditions in a reducible or inert atmosphere.

More specifically, the method of manufacturing the refrigerant distributor according to the present invention is stepwisely described below.

In the preparation of the mixture, copper powder is used as the base material, and the base material is mixed with 30˜70 vol % of a binder based on the total volume thereof, thus preparing the mixture for injection molding.

The binder is used to impart flowability to copper powder so that copper powder is uniformly injected into the mold in a subsequent injection procedure and to increase the strength of an injection molded body produced using the mold, and is composed of paraffin wax, polyethylene, polypropylene, and stearic acid which are quantitatively admixed. In the preparation of the mixture, the copper powder and the binder are homogeneously mixed using a twin screw extruder or a 2-blade mixer.

In the production of the injection molded body from the mixture including the copper powder and the binder, a mold having the shape of a distributor is used, and the mixture obtained in the previous step is placed into such a mold, thus producing the injection molded body having the shape of a distributor.

Subsequently, in the removal of the binder from the injection molded body, the binder is removed through a solvent debinding process by which the binder contained in the injection molded body is dissolved using a solvent including n-hexane, heptane or alcohol, and through a thermal debinding process by which the injection molded body is heated to burn and remove the binder, which has not been removed through solvent debinding and remains.

In the thermal debinding process, the injection molded body is heated in a furnace in a reducible or inert atmosphere, thereby preventing oxidation of the molded body which may occur during thermal debinding. After the thermal debinding, a presintering process for increasing the strength of the molded body is preferably carried out under conditions in which the temperature of the furnace is increased.

Finally, in the sintering of the binder-free injection molded body, the molded body is sintered in a sintering furnace under predetermined temperature conditions, thereby obtaining as a final product a distributor having improved density and mechanical strength.

In this procedure, the sintering temperature may vary depending on the particle size and purity of the copper powder, which is the main material of the injection molded body, and the type of additive, but sintering is conducted in a sintering furnace under temperature conditions of about 800˜1150° C. In the case of copper powder, there is a concern about oxidation occurring during the sintering process, and thus, sintering is carried out in a reducible atmosphere containing hydrogen gas or an inert atmosphere of nitrogen or argon gas or under a vacuum state. The sintering time may vary depending on the required properties, but is set within the range of from about 30 min to about 3 hours.

In particular, it is preferred that the thermal debinding process for removing the binder and the sintering process for sintering the binder-free molded body be not separately performed but be simultaneously conducted in a sintering furnace in a reducible or inert atmosphere. In this case, in the course of sintering the injection molded body from which part of the binder has been removed through solvent debinding, thermal debinding may be performed concomitantly therewith. Accordingly, the manufacturing process may become simplified, thereby making it possible to realize mass productivity of better products.

According to the manufacturing method of the present invention, it is possible to manufacture a distributor having a desired shape and size through injection and sintering. Hence, because the need to press and braze the distributor as in the conventional case is eliminated, the thickness and length of the copper pipe required for pressing and brazing are no longer limited. Consequently, the method of the present invention is very suitable for making the size of the heat exchanger and the refrigerant pipe compact while minimizing loss of material.

Further, in the course of producing the injection molded body, protrusions for guiding and limiting the insertion depth of a connection pipe upon assembly with the connection pipe may be formed using cores. That is, an additional process for forming protrusions on the final distributor in the conventional case, specifically, the punching process, may be omitted.

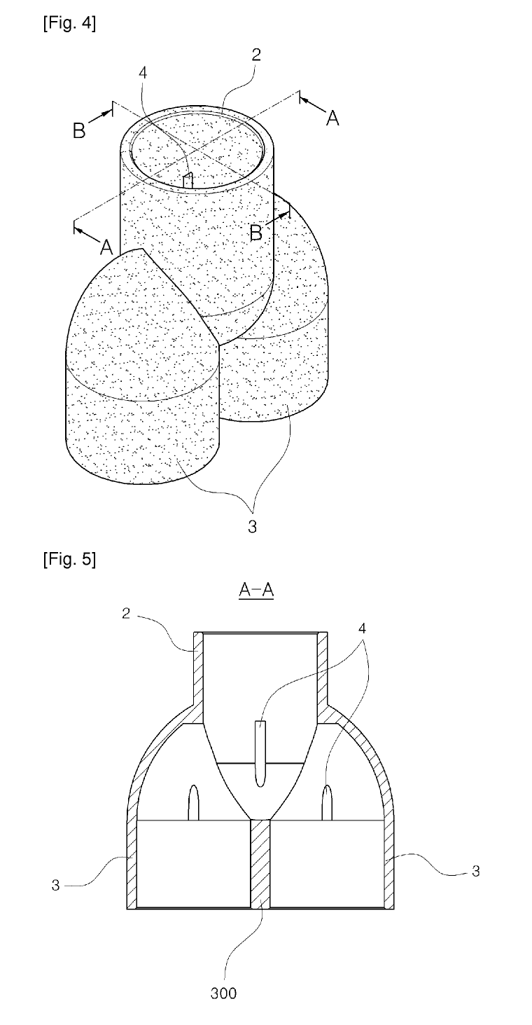

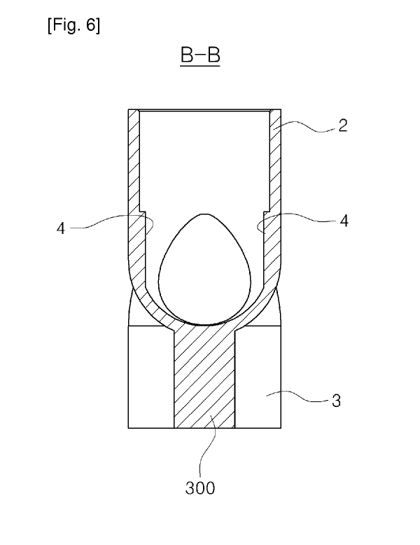

FIGS. 4 to 6 show the refrigerant distributor manufactured through the above manufacturing process according to the present invention. FIG. 4 is a perspective view showing the refrigerant distributor according to the present invention, and FIGS. 5 and 6 are cross-sectional views of the refrigerant distributor taken along the lines A-A and B-B of FIG. 4, respectively.

As shown in the drawings, in the refrigerant distributor manufactured through the method of the present invention, a single inlet portion 2 and two outlet portions 3 communicate with each other to provide an integrated form, in which the two outlet portions 3 have a central partition 300 disposed therebetween, and the inlet portion 2 and the outlet portions 3 have protrusions 4 which are integrally formed on the inner surfaces thereof to guide and limit the insertion depth of a connection pipe (not shown) which is fitted into the refrigerant distributor and is connected thereto.

In the refrigerant distributor according to the present invention, the distributor is manufactured through the above sintering process, and thus the final distributor includes no brazed portions unlike in the conventional case. Accordingly, there is no concern about the melting of the brazed portions, which may be caused during the welding of the connection pipe to the distributor, and thus the unbalanced flow of the refrigerant and leakage thereof are prevented.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A method of manufacturing a refrigerant distributor for air conditioning, comprising:
mixing copper powder which is a base material with 30-60 vol % of a binder based on a volume of the copper powder, thus preparing a mixture for injection molding;
subjecting the prepared mixture to injection molding using a mold, thus producing an injection molded body having a shape of a distributor;
performing solvent debinding by which the binder contained in the injection molded body having the shape of a distributor is dissolved using a solvent to remove the binder;
performing thermal debinding by which the injection molded body having the shape of a distributor is heated to burn and remove the binder which has not been removed through solvent debinding; and
sintering the molded body from which the binder has been removed in a sintering furnace at 800-1150° C. in a reducible or inert atmosphere.

2. The method according to claim 1, wherein the performing the thermal debinding and the sintering the molded body are simultaneously conducted in the sintering furnace in a reducible or inert atmosphere.

3. The method according to claim 1, wherein the solvent used in the solvent debinding is a solvent including n-hexane, heptane or alcohol.

4. A refrigerant distributor for air conditioning, which is manufactured through the method of claim 1 and comprises a single inlet portion and two outlet portions which communicate with each other to provide an integrated form, and the inlet portion and the outlet portions have protrusions which are integrally formed on inner surfaces thereof to guide and limit an insertion depth of a connection pipe which is connected to the distributor.

5. A refrigerant distributor for air conditioning, which is manufactured through the method of claim 2 and comprises a single inlet portion and two outlet portions which communicate with each other to provide an integrated form, and the inlet portion and the outlet portions have protrusions which are integrally formed on inner surfaces thereof to guide and limit an insertion depth of a connection pipe which is connected to the distributor.

6. A refrigerant distributor for air conditioning, which is manufactured through the method of claim 3 and comprises a single inlet portion and two outlet portions which communicate with each other to provide an integrated form, and the inlet portion and the outlet portions have protrusions which are integrally formed on inner surfaces thereof to guide and limit an insertion depth of a connection pipe which is connected to the distributor.
